(19) United States
(12) Patent Application Publication
(10) Pub. No.: US 2005/0094194 A1
(43) Pub. Date: May 5, 2005

(54) Enhanced image processing with shared data storage

(76) Inventors: David Dolev, Ness Ziona (IL); Robert Douglas Christiansen, Boise, ID (US); Robert E. Stevahn JR., Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/701,299

(22) Filed: Nov. 3, 2003

(51) Int. Cl. G06F 15/00

(52) U.S. Cl. 358/1.15; 358/1.13

(57) ABSTRACT

Systems and methods for enhancing image processing with shared data storage are described. In one aspect, a raster image process (RIP) manager is coupled to multiple RIP engines, shared virtual memory (VM), and an imaging device. The RIP manager divides an imaging job into multiple partitions, individual ones of which are distributed to specific ones of the RIP engines for processing. The RIP manager receives multiple partition status messages, each indicating that a particular one partition has been rasterized into data that is stored by a respective one of the RIP engines into shared virtual memory (VM). Responsive to determining via received partition status messages that all of the multiple partitions have completed RIPing, information extracted from each of the partition status messages is communicated to the imaging device for printing or presenting data rasterized from the imaging job via the shared VM.

### TECHNICAL FIELD

Systems and methods of the invention pertain to image processing.

### BACKGROUND

In printing environments, digital vector data is generally expressed in Page Description Language (PDL) data format. PDL includes, for example, Printer Control Language® (PCL), Portable Document Format® (PDF), or PostScript® (PS). In photo shop environments, digital vector data are typically represented as JPEG, TIFF, and/or like data formats (such data formats can also be present in a print job). Prior to printing or otherwise presenting image data in any one of these digital vector data formats, the image data must be rasterized. Rasterization or “raster image processing” (“RIPing”) is the process of translating digital vector data into bit-mapped data or raster bits for rendering by a printer or display device.

For instance, in a networked print shop environment, a centralized RIP Manager may divide a large print job into multiple partitions for delivery to multiple RIP engines. These RIP engines are generally distributed across multiple different networked computing devices. As each RIP engine completes RIPing an assigned portion of the print job, corresponding raster bits (“RIP′d data”) are compressed and sent back to the RIP manager. Subsequent to receiving compressed raster bits for all of the respective print job partitions, the RIP manager decompresses the compressed data (a first compression/decompression cycle) for sorting based on print job order. The RIP manager then aggregates the sorted data and compresses it to generate a single file that is then sent to a printing device such as a printing press. The print device then decompresses the compressed raster bits (a second compression/decompression cycle) to print the raster bits.

As a result of such RIPing operations, many local and device-to-device data transfers, as well as compression and decompression cycles must be performed. Unfortunately, such operations are computer resource processing and memory intensive. To make matters worse, multiple network and memory data transfers are time consuming and may require substantially prohibitive amounts of valuable computing device and network bandwidth. As a result, operational availability of machines hosting the RIP manager, print processor, and/or printing press, as well as different network resources may be negatively affected, possibly causing them to slow down and even become unavailable. In print and photo shop document processing environments, computing and network resource slowdown and unavailability can have a substantially negative impact on desired job workflow

### SUMMARY

Systems and methods for enhancing image processing with shared data storage are described. In one aspect, a raster image process (RIP) manager is coupled to multiple RIP engines, shared virtual memory (VM), and an imaging device. The RIP manager divides an imaging job into multiple partitions, individual ones of which are distributed to specific ones of the RIP engines for processing. The RIP manager receives multiple partition status messages, each indicating that a particular one partition has been rasterized into data that is stored by a respective one of the RIP engines into shared virtual memory (VM). Responsive to determining via received partition status messages that all of the multiple partitions have completed RIPing, information extracted from each of the partition status messages is communicated to the imaging device for printing or presenting data rasterized from the imaging job via the shared VM.

### BRIEF DESCRIPTION OF THE DRAWINGS

The detailed description is described with reference to the accompanying figures.

FIG. 1 is one exemplary embodiment of a suitable computing environment within which systems, apparatuses and methods to enhance image processing with shared data storage may be implemented.

FIG. 2 shows one exemplary embodiment of a procedure for a RIP Manager to enhance image processing with shared data storage.

FIG. 3 shows one exemplary embodiment of a procedure for a RIP engine to enhance image processing with shared data storage.

FIG. 4 shows one exemplary embodiment of a procedure for a print device to enhance image processing with shared data storage.

### DETAILED DESCRIPTION

Overview

The following systems and procedures utilize only a single compression/decompression cycle to RIP multiple partitions of a print/photo job and to print/present corresponding data. In one implementation, compressed RIP′d data is stored by respective RIP engines into shared VM in a Storage Area Network (SAN). To print these raster bits, a print device accesses the compressed raster bits from the shared VM for decompression and printing. This results in only a single compression/decompression cycle to RIP and print digital vector data. The compression is performed by the RIP engines and the decompression is performed by an imaging device such as a printer or video card of a display monitor. By reducing the compression/decompression cycles as compared to conventional systems, the following described systems and techniques free-up a substantial number of computer processing and memory resources and reduce data throughput requirements and network transmission times as compared to conventional systems.

An Exemplary Operating Environment

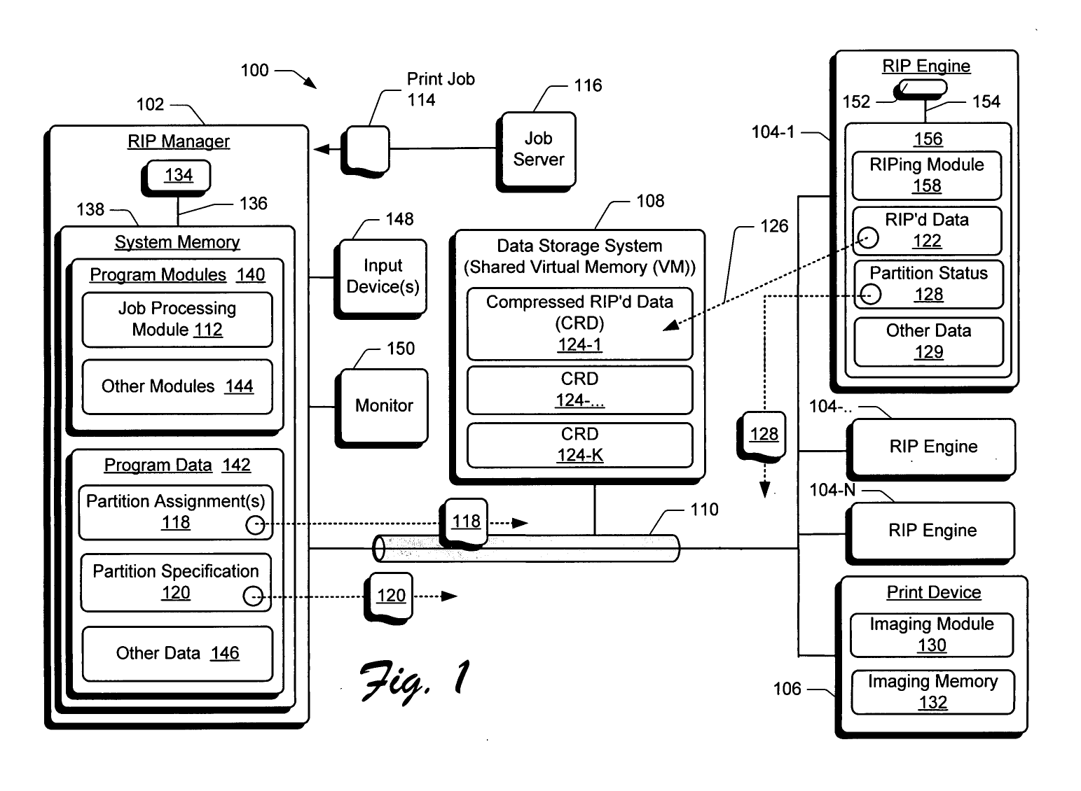

Turning to the drawings, wherein like reference numerals refer to like elements, the systems and methods are illustrated as being implemented in a suitable computing environment. FIG. 1 is an exemplary embodiment of one suitable computing environment 100 within which systems, apparatuses and methods to enhance image processing with shared data storage may be implemented. Exemplary computing environment 100 is only one example of a suitable computing environment and is not intended to suggest any limitation as to the scope of use or functionality of systems and methods the described herein.

Although not required, the invention will be described in the general context of computer-executable instructions, such as program modules executed in a distributed computing environment by a computer. Program modules generally include routines, programs, objects, components, data structures, etc., that perform particular tasks or implement particular abstract data types. In a distributed computing environment, program modules may be located in both local and remote memory storage devices.

As shown in FIG. 1, exemplary computing environment 100 includes RIP Manager 102, one or more RIP engines 104-1 through 104-N, Print Device 106, and a Data Storage System 108 such as a RAID in a Storage Area Network (SAN) architecture. These system components are coupled to one-another over Communication Path 110. The Communication Path 110 represents any type of physical or wireless network communication infrastructure deployed, for example, as an organizational Intranet. The Data Storage System 108 includes one or more disk drives or other computer-readable media that are addressable by each of the RIP Manager 102, the RIP engines 104-1 through 10-N, and the Print Device 106 for data storage and access operations. In other words, the Data Storage System represents shared virtual memory (VM) for the indicated components of the exemplary computing environment 100.

In this implementation, the Job Processing Module 112 of the RIP Manager 102 receives a Print Job 114 from job server 116. The print job includes, for example, print data expressed in Page Design Language (PDL) to be rendered by the printing device 106. To this end, the Job Processing Module 112 divides the print data into multiple partitions. A partition is some number of pages of the print job. The pages in any one partition may be consecutive or non-consecutive. The Job Processing Module 112 assigns the partitions to selected ones of the RIP engines 104-1 thorough 104-N for RIPing. Such assignments are represented by the Partition Assignment(s) 118 portion of the program data 142. A partition assignment 118 can be based on any number of different criteria such as RIP engine availability, partition size, current and/or anticipated print shop workflow, and so on.

Each partition assignment 118 indicates a number of pages of the Print Job 114 that are to be RIP′d by a specific RIP engine 104-1 through 104-N. The Partition Assignment(s) 118 are mapped in the Partition Specification 120, which is also referred to as a job layout. Besides including the partition assignments, the Partition Specification 120 also indicates partition ordering as a function of the print job's particular layout, and a RIP status for each specified partition. When a partition is assigned to a specific RIP engine 104-1 through 104-N, the Job Processing Module 112 updates the RIP status for the partition from an “unassigned” status to an “assigned” status (or equivalent value).

The Job Processing Module 112 sends Partition Assignment(s) 118 to respective ones of the RIP engines 104-1 through 104-N. Responsive to receiving a partition assignment and in this particular implementation, a RIP engine 104 (one of the RIP engines 104-1 through 104-N) determines whether it has a copy of the Print Job 114 in a memory local to the RIP engine that is accessible by the RIP engine. If the print job is not stored in such local memory, then the RIP engine requests a copy of the print job from the RIP Manager 102. Responsive to receiving such a request, the RIP Manager transmits a copy of the print job to the requesting RIP engine. In this implementation, the print job is communicated only a single time to any one of the RIP engines.

In this implementation, once a Print Job 114 has been communicated to a particular RIP engine 104-1 through 104-N, the print job is then available in the local memory of the RIP engine for RIPing of any subsequently assigned partitions of the print job. (For purposes of discussion, local RIP engine memory is shown as system memory 156 of FIG. 1, and one or more portions of the Print Job 114 stored in memory accessible to the RIP engine are represented as respective portions of other data 129). In a different implementation, only portions of the print job corresponding to the portions targeted for operation by a requesting RIP engine are communicated by the RIP Manager to the RIP engine.

Subsequent to determining that a copy of the Print Job 114 is available, a RIP engine 104-1 through 104-N determines the one or more specific pages of the Print Job 114 to RIP, as specified in Partition Assignment(s) 118. The RIP engine RIPs the one or more pages, thereby generating RIP′d data 122. Although not shown for each respective one of the RIP engines, each RIP engine that is assigned a partition via Partition Assignment(s) 118 will RIP the partition to generate a respective RIP′d Data 122.

A RIP engine 104-1 through 104-N stores RIP′d data 122 into the Data Storage System (DSS) 108. The RIP engine may wait until an entire partition of the Print Job 114 is RIP′d before storing the associated RIP′d data into the DSS 108, or the RIP engine may iteratively/periodically store portions of the RIP′d data into the DSS as RIPing operations progress. In this implementation, the DSS 108 is shared virtual memory (VM), and is hereinafter often referred to as VM 108. Each RIP′d data 122 stored in the VM 108 is in a compressed data format, and for purposes of discussion, is represented by at least one of the compressed RIP′d data (CRD) blocks 124-1 through 124-K. For instance, callout 126 indicates that at least a portion of RIP′d Data 122 of RIP engine 104-N is represented in shared VM 108 as CRD 124-1. A different portion of the RIP′d data 122 may be represented as CRD 124- . . . , and so on. Each RIP engine 104-1 through 104-N stores respective portions of RIP′d data 122 into the shared VM 108 in a similar manner. The manner in which CRD's 124 are arranged in the VM 108 is independent of any data sorting relationship between the stored CRDs and the layout of the Print Job 114.

Subsequent to RIPing an assigned partition of the Print Job 114, a RIP engine 104-1 through 104-N notifies the Job Processing Module 112 of the RIP Manager 102 that RIPing operations for the assigned partition have been completed. To this end, the RIP engine sends a Partition Status 128 to the Job Processing Module 112. The Partition Status 128 includes, for example, a substantially unique identifier (ID) to differentiate the particular partition from other print job partitions, a start address of the corresponding block of CRD 124-1 through 124-K in VM, and the byte size of the corresponding CRD block. Responsive to receiving the Partition Status, the Job Processing Module 112 updates the Partition Specification 120 with the received Partition Status information. In this manner, the Job Processing Module 112 determines when the RIPing process for each of the print job partitions that make-up a Print Job 114 has been completed.

Additionally, when a RIP engine 104-1 through 104-N sends a Partition Status 128 to the Job Processing Module 112, the RIP engine has in effect notified the RIP Manager 102 that the RIP engine is available to RIP more data. In view of this, in one implementation, if there are unassigned partitions of the Print Job 114, the Job Processing Module 112 assigns one or more of the remaining partitions to the Print Job 114 to the Partition Status sending RIP engine for RIPing.

Once all print job partitions have been RIP′d by respective ones of the RIP engines 104-1 through 104-N, the Job Processing Module 112 notifies the Print Device 106 of the respective VM start addresses and sizes of each CRD 124-1 through 124-K that is associated with the Print Job 114, as well as the order to decompress and print the CRDs. To accomplish this, the Job Processing Module 112 merely sends the print specification 120, which is a job layout file to the Print Device 106. Responsive to receiving the Partition Specification 120, the Print Device 106, and more particularly the Imaging Module 130 of the Print Device 106, accesses each CRD block in the specified order from shared VM 108 for swapping into its image memory 132 for subsequent decompression and printing.

As shown in FIG. 1, the RIP Manager 102 includes, for example, a processor 134 coupled across a bus 136 to a system memory 138. The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus, also known as Mezzanine bus.

System memory 138 includes a variety of computer readable media. Such media may be any available media that is accessible by RIP Manager 102, and it includes both volatile and non-volatile media, removable and non-removable media. In particular, the system memory includes computer-readable media in the form of non-volatile memory, such as read-only memory (ROM), and/or volatile memory, such as random access memory (RAM). The RIP Manager 102 may further include other removable/non-removable, volatile/non-volatile computer storage media (not shown) such as a hard disk drive, a CD-ROM, a magnetic tape drive, and so on.

The RAM portion of the system memory 138 contains program modules 140 and program data 142 that are immediately accessible to and/or presently being operated on by the processor 134. For instance, the program modules 140 include Job Processing Module 112 and other and other modules 144 such as an operating system (OS) to provide a runtime environment, a RIP resource pipeline configuration routine, and/or the like. The Job Processing Module 112 performs numerous operations to enhance image processing with shared data storage, as described above. The program data 142 includes, for example, Print Job 114, Partition Assignment(s) 118, Partition Specification 120, and Other Data 146 such as workflow scheduling data, etc.

A user may provide commands and information into the RIP Manager 102 through one or more input devices 148 such as a keyboard and pointing device such as a “mouse”. Other input devices may include a scanner, camera, etc. These and other input devices are connected to the processing unit 134 through an input interface (not shown) coupled to the bus 136, but may be connected by other interface and bus structures, such as a parallel port, game port, or a universal serial bus (USB). Optionally, the RIP Manager 102 may also be coupled to a monitor 150 with a video display card for decompressing and presenting CRD 124-1 through 124-K.

Rip engines 104-1 through 104-N can be implemented across any number of computing devices. Such computing devices include, for example, a processor 152 coupled across a bus 154 to a system memory 156. The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus, also known as Mezzanine bus.

System memory 156 includes a variety of computer readable media. Such media may be any available media that is accessible by the RIP engine, and it includes both volatile and non-volatile media, removable and non-removable media. In particular, the system memory includes computer-readable media in the form of non-volatile memory, such as read-only memory (ROM), and/or volatile memory, such as random access memory (RAM). The RIP engine may further include other removable/non-removable, volatile/non-volatile computer storage media (not shown) such as a hard disk drive, a CD-ROM, a magnetic tape drive, and so on.

The RAM portion of the system memory 156 contains program modules and program data that are immediately accessible to and/or presently being operated on by the processor 152. For instance, the program modules include RIPing module 158 to enhance image processing operations with shared data storage, as described above. The program data includes, for example, RIP′d data (RD) 122, Partition Status 128, and Other Data 129.

The Print Device 106 also includes a processor such as those described and shown above coupled to a bus and a system memory. The system memory comprises a program modules portion comprising computer-program instructions executable by the processor such as the Imaging Module 130 described above. The system memory further comprises a program data portion comprising the Imaging Memory 132 for decompression and printing of the CRD's 124-1 through 124-K by the Imaging Module.

An Exemplary Procedure

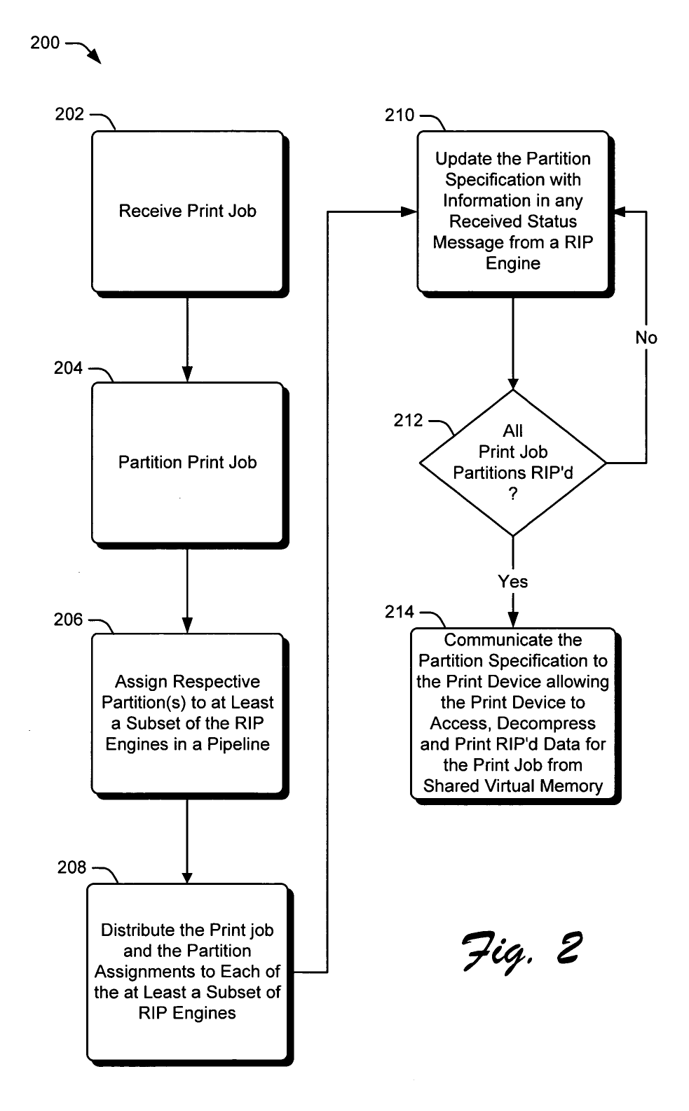

FIG. 2 shows an exemplary embodiment of a procedure 200 for RIP Manager 102 to enhance image processing with shared data storage. For purposes of discussion, the exemplary procedure is described in reference to features of FIG. 1. In the figures, the left-most digit of a component reference number identifies the particular figure in which the component first appears. At block 202, the Job Processing Module 112 (FIG. 1) of the RIP Manager 102 receives a Print Job 114. At block 204, the Job Processing Module 112 partitions the print job. At block 206, the Job Processing Module 112 assigns respective partition(s) to at least a subset of the RIP engines 104-1 through 104-N (FIG. 1) and identifies such assignments in the Partition Assignment(s) 118 (FIG. 1). For purposes of discussion, the RIP engines in the at least a subset are referred to as designated RIP engines. At block 208, Job Processing Module 112 delivers the print job and the Partition Assignment(s) 118 to the designated RIP engines.

As the designated RIP engines 104-1 through 104-N complete their respective RIPing operations, they send corresponding Partition Status messages 128 (FIG. 1) to the RIP Manager 102 (FIG. 1). At block 210, responsive to receiving a Partition Status message, the Job Processing Module 112 (FIG. 1) extracts information from the Partition Status message to update the Partition Specification 120 with the information. Such information includes, for example, start addresses of a block of RIP′d data that is stored in shared VM of a Data Storage System 108 (FIG. 1), and the size of the RIP′d data. At block 212, the Job Processing Module 112 determines whether all partitions of the Print Job 114 have been RIP′d. This is accomplished by parsing the Partition Specification 120 to identify whether any of the print job partitions have not completed RlPing operations.

If all of the partitions have not been RIP′d, the procedure 200 continues at block 210 as described above. Otherwise, at block 214, the Job Processing Module 112 communicates the Partition Specification 120 to the Print Device 106 (FIG. 1). The information in the Partition Specification 120 provides the Print Device 106 with the shared VM addresses and the associated size of each compressed block of RIP′d data 124-1 through 124-K (FIG. 1), each compressed block corresponding to RIP′d data from one of the partitions in the print job. The print job uses this information to access, decompress, and print the blocks of RIP′d data.

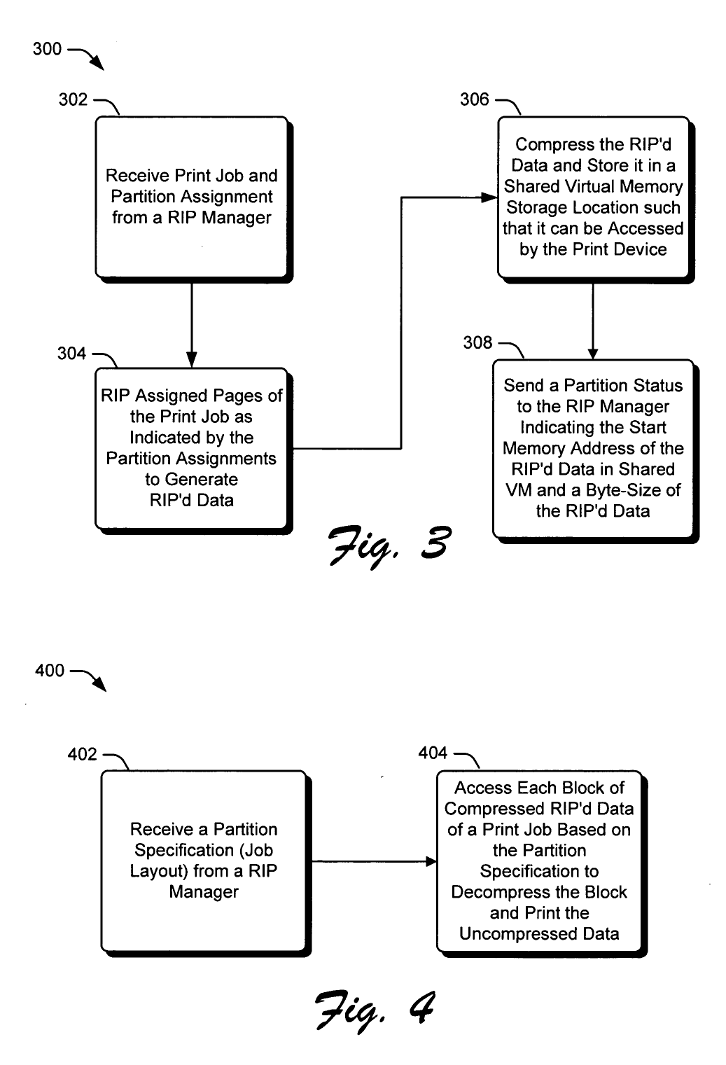

FIG. 3 shows an exemplary embodiment of a procedure 300 for a RIP engine to enhance image processing with shared data storage. For purposes of discussion, the exemplary procedure is described in reference to features of FIGS. 1 and 2. In the figures, the left-most digit of a component reference number identifies the particular figure in which the component first appears. At block 302, RIPing module 158 (FIG. 1) of a RIP engine 104 (one of the RIP engines 104-1 through 104-N) receives Print Job 114 (FIG. 1) and a Partition Assignment(s) 118 (FIG. 1) from RIP Manager 102 (FIG. 1). (See also; block 208 of FIG. 2, wherein the RIP Manager 102 sends such data to RIP engines). At block 304, the RIPing module 158 RIPs the particular pages of the print job 114 as indicated in the Partition Assignment(s) 118. At block 306, the RIPing module compresses the data generated by the RIPing operation and stores the compressed data (i.e., one of CRDs 124-1 through 124-K) into shared VM 108.

At block 308, the RIPing module 158 sends a Partition Status 128 (FIG. 1) to the RIP Manager 102. (See also; block 210 of FIG. 2, wherein the RIP Manager 102 receives such a Partition Status message 128). The Partition Status 128 includes, for example, a start address of the shared VM 108 where the corresponding CRD block 124 (one of the CRD's 124-1 through 124-K) is stored, and the number of bytes written to the shared VM (i.e., the corresponding CRD block-size).

FIG. 4 shows an exemplary embodiment of a procedure 400 for a Print Device 106 to enhance image processing with shared data storage 108. For purposes of discussion, the exemplary procedure is described in reference to features of FIGS. 1 and 2, which were discussed above. In the figures, the left-most digit of a component reference number identifies the particular figure in which the component first appears. At block 402, the Print Device 106 (FIG. 1) and more specifically the Imaging Module 130 receives a Partition Specification 120 (FIG. 1) from the RIP Manager 102 (FIG. 1). (See also; block 214 of FIG. 2, wherein the RIP Manager 102 communicates the Partition Specification 120 to the Print Device).

At block 404, the Imaging Module 130 accesses each CRD 124-1 through 124-K (FIG. 1) based on the information in the Partition Specification 120. To this end, for each CRD 124, the Imaging Module 130 locates the corresponding start address for the CRD 124 in the shared VM 108 via the Partition Specification 120. The Imaging Module 130 swaps those bytes of the CRD into its Imaging Memory 132 for decompression and printing. Once the Print Device 106 has completed printing the swapped bytes, the Print Device 106 obtains a next CRD 124 (a particular one of the CRDs 124-1 through 124-K) block for decompression and printing, as described above. These operations are continued until all CRD blocks 124 corresponding to the print job 114 have been decompressed and printed.

Conclusion

The described systems and methods enhance image processing with shared data storage. Although the systems and methods have been described in language specific to structural features and methodological operations, the subject matter as defined in the appended claims are not necessarily limited to the specific features or operations described. For example, although the exemplary system 100 of FIG. 1 has been described with respect to a printing environment, the described systems and techniques can also be applied to a photo imaging environment, and/or different types of imaging environments, wherein the digital vector data is not PDL but rather of a different data format such as JPEG or TIFF. Accordingly, the specific features and operations are disclosed as exemplary forms of implementing the claimed subject matter.

1. In a distributed computing environment, a method for enhancing image processing with shared data storage, the distributed computing environment comprising a raster image process (RIP) manager coupled to multiple RIP engines, shared virtual memory (VM), and an imaging device, the method comprising:
dividing, by the RIP Manager, an imaging job into multiple partitions;
distributing, by the RIP Manager, individual ones of the multiple partitions to specific ones of the RIP engines for raster image processing (RIPing);
receiving, by the RIP Manager, a plurality of partition status messages, each Partition Status message indicating that a particular one of the multiple partitions has completed RIPing and rasterized data associated with the particular one partition has been stored by a respective one of the RIP engines into shared virtual memory (VM); and
responsive to determining via received partition status messages that all of the multiple partitions have completed RIPing, the RIP Manager communicating information extracted from each of the partition status messages to the imaging device for printing or presenting data rasterized from the imaging job via the shared VM.

2. A method as recited in claim 1, wherein the imaging job is a print job.

3. A method as recited in claim 1, wherein the operations of dividing, receiving, determining, and communicating are performed by a RIP Manager in a printing environment.

4. A method as recited in claim 1, wherein the imaging device is a printer or a display monitor.

5. A method as recited in claim 1, wherein the shared VM is a data storage system such as a RAID in a storage access network (SAN).

6. A method as recited in claim 1, wherein for each of multiple blocks of compressed raster data stored in the shared VM, the information comprises a respective start address for the block in the shared VM and a byte-size of the block.

7. A method as recited in claim 1, wherein the method further comprises enabling the imaging device via the information to access individual ones of multiple blocks of compressed raster data from the shared VM, each block of the multiple blocks representing rasterized data for a specific one of the multiple partitions.

8. A method as recited in claim 1, wherein the method further comprises enabling the imaging device via the information to print or present the data independent of transferring a single aggregated file comprising all rasterized bits from the imaging job to the imaging device.

9. A method as recited in claim 1, wherein the method further comprises:
receiving, by a RIP engine of the RIP engines, the imaging job and a partition assignment from the RIP Manager, the partition assignment corresponding to a particular one partition of the partitions;
raster image processing (RIPing) the particular one partition by the first RIP engine to generate a block of raster bits;
compressing by the RIP engine the block of raster bits;
storing by the RIP engine compressed raster bits of a specific size into the shared VM at a start address; and
responsive to storing the compressed raster bits, communicating by the RIP engine a status to the RIP Manager, the status comprising at least the start address and the specific size, the status being one of the partition status messages.

10. A method as recited in claim 1, wherein the method further comprises:
receiving, by the imaging device, a partition specification comprising the information; and
for each of multiple blocks of the data, decompressing and printing, by the imaging device, the block based on the information.

11. A computer-readable media comprising computer-program instructions executable by a processor for enhancing image processing with shared data storage in storage area network, the computer-program instructions comprising instructions for:
dividing an imaging job into multiple partitions;
distributing individual ones of the multiple partitions to specific ones of multiple raster image process (RIP) engines for raster image processing (RIPing);
receiving a plurality of partition status messages, each partition status message indicating that a particular one of the multiple partitions has completed RIPing and rasterized data associated with the particular one partition has been stored by a respective one of the RIP engines into shared virtual memory (VM); and
responsive to determining via received partition status messages that all of the multiple partitions have completed RIPing communicating information extracted from each of the partition status messages to an imaging device for printing or presenting data rasterized from the imaging job via the shared VM.

12. A computer-readable media as recited in claim 11, wherein the imaging job is a print job.

13. A computer-readable media as recited in claim 11, wherein the instructions for dividing, receiving, determining, and communicating are performed by a RIP Manager in a printing environment

14. A computer-readable media as recited in claim 11, wherein the imaging device is a printer or a display monitor.

15. A computer-readable media as recited in claim 11, wherein the shared VM is a data storage system such as a RAID.

16. A computer-readable media as recited in claim 11, wherein for each of multiple blocks of compressed raster data stored in the shared VM, the information comprises a respective start address for the block in the shared VM and a byte-size of the block.

17. A computer-readable media as recited in claim 11, wherein for each of multiple blocks of compressed raster data stored in the shared VM, the information comprises a respective start address for the block in the shared VM and a byte-size of the block, and wherein the computer-program instructions further comprise instructions for providing the information to a requesting computing device as a list.

18. A computer-readable media as recited in claim 11, wherein the computer-program instructions further comprise instructions for enabling the imaging device via the information to access individual ones of multiple blocks of compressed raster data from the shared VM, each block of the multiple blocks representing rasterized data for a specific one of the multiple partitions.

19. A computer-readable media as recited in claim 11, wherein the computer-program instructions further comprise instructions for enabling the imaging device via the information to print or present the data independent of transferring a single aggregated file comprising all rasterized bits from the imaging job to the imaging device.

20. A raster image process (RIP) manager for enhancing image processing with shared data storage, the RIP Manager being configured for coupling over a communication network to multiple RIP engines, a shared data storage system, and an imaging device, the RIP Manager comprising:
a processor; and
a memory coupled to the processor, the memory comprising computer-program instructions executable by the processor for:
dividing an imaging job into multiple partitions;
distributing individual ones of the multiple partitions to specific ones of the RIP engines for raster image processing (RIPing);
receiving a plurality of partition status messages, each partition status message indicating that a particular one of the multiple partitions has completed RIPing and rasterized data associated with the particular one partition has been stored by a respective one of the RIP engines into the shared data storage system; and
responsive to determining via received partition status messages that all of the multiple partitions have completed RIPing, communicating information extracted from each of the partition status messages to the imaging device for printing or presenting data rasterized from the imaging job via the shared VM.

21. A RIP Manager as recited in claim 20, wherein the imaging job is a print job.

22. A RIP Manager as recited in claim 20, wherein the imaging device is a printer or a display monitor.

23. A RIP Manager as recited in claim 20, wherein the shared data storage system is a RAID in a storage access network (SAN).

24. A RIP Manager as recited in claim 20, wherein for each of multiple blocks of compressed raster data stored in the shared data storage system, the information comprises a respective start address for the block in the shared data storage system and a byte-size of the block.

25. A RIP Manager as recited in claim 20, wherein the computer-program instructions further comprise instructions for enabling the imaging device via the information to access individual ones of multiple blocks of compressed raster data from the shared VM, each block of the multiple blocks representing rasterized data for a specific one of the multiple partitions.

26. A RIP Manager as recited in claim 20, wherein the computer-program instructions further comprise instructions for enabling the imaging device via the information to print or present the data independent of transferring a single aggregated file comprising all rasterized bits from the imaging job to the imaging device.

27. A raster image process (RIP) engine for enhancing image processing with shared data storage, the RIP engine being configured for coupling over a communication network to a RIP Manager, multiple other RIP engines, a shared data storage system, and an imaging device, the RIP Manager comprising:
a processor; and
a memory coupled to the processor, the memory comprising computer-program instructions executable by the processor for:
receiving the imaging job and a partition assignment from the RIP Manager, the partition assignment corresponding to a particular one partition of multiple partitions associated with the imaging job;
raster image processing (RIPing) the particular one partition to generate a block of raster bits;
compressing the block of raster bits;
storing compressed raster bits of a specific size into the shared data storage system at a start address; and
responsive to storing the compressed raster bits, enabling the imaging device to access the compressed raster bits from the shared data storage system via the start address and the specific size.

28. A RIP engine as recited in claim 27, wherein the instructions for enabling further comprise instructions for sending a partition status to the RIP Manager, the partition status comprises at least the start address and the specific size.

29. A printing device for enhancing image processing with shared data storage, the printing device being configured for coupling over a communication network to a RIP Manager, multiple RIP engines, and a data storage system shared at least with the multiple RIP engines, the printing device comprising:
a processor; and
a memory coupled to the processor, the memory comprising computer-program instructions executable by the processor for:
receiving a Partition Specification comprising a respective start address and a respective byte size for each of multiple blocks of compressed raster image processed (RIP′d) data stored in the data storage system; and
for each of the multiple blocks, decompressing and printing a number of bytes from the respective start address, the number of bytes being the respective byte size.
